(19) United States
(12) Patent Application Publication
(10) Pub. No.: US 2026/0022001 A1
(43) Pub. Date: Jan. 22, 2026

(54) LEVER FOR A PULL-ACTUATED DEVICE

(71) Applicant: Juan Calderon, Chino, CA (US)

(72) Inventor: Juan Calderon, Chino, CA (US)

(21) Appl. No.: 18/778,216

(22) Filed: Jul. 19, 2024

(51) Int. Cl. B66F 15/00

(52) U.S. Cl. CPC B66F 15/00

(57) ABSTRACT

A lever apparatus for pulling a knob actuator away from a base via a pushing action includes an engagement section which has a shape configured for being abutted against an underside of a head of the actuator knob. A fulcrum section is coupled to one end of the pair of ends of the engagement section. A grip section is coupled to the fulcrum section opposite the engagement section. During use, the engagement section of the lever apparatus is fitted around a body of the actuator knob, and the fulcrum abuts the base to which the actuator knob is movably mounted. The grip section is pressed toward the base to rotate or rock the fulcrum section against the base and pivot the engagement section into the head of the actuator knob, thereby pulling the actuator knob away from the base.

### BACKGROUND OF THE INVENTION

### (1) Field of the Invention

The disclosure relates to levers and more particularly pertains to a new lever for pulling a knob actuator away from a base via a pushing action.

### (2) Description of Related Art Including Information Disclosed Under 37 CFR 1.97 and 1.98

The prior art relates to levers and prying tools. Myriad levers are known to the prior art. For example, U.S. Pat. No. 3,666,238 discloses a lever which includes a head, a resilient member, and a handle. The resilient member is coupled to and positioned between the head and the handle. The head has prongs which may be inserted under a windshield wiper arm assembly. The handle is rotated while the resilient member abuts a windshield to lift the windshield wiper arm assembly from the windshield without damaging the windshield.

A need is present, however, for a lever which may be used to pull a knob of an actuator away from a base of the actuator via a pushing force. Pulling such knobs can be strenuous and may especially cause harm to joints when the actuator is difficult to move or requires frequent use. By providing a lever that can convert a pushing force into the pulling force required to operate the actuator, injury and pain may be avoided or lessened in situations where an individual may be less prone to injury from applying a pushing force. Pulling and pushing the actuator may be interchanged to avoid repetitive actions. It may also be easier to use body weight, weighted tools, or impact tools to operate the actuator via a pushing force, limiting exposure to injury. Such a lever may also be shaped to hang onto the knob when not in use so that the lever is not misplaced.

### BRIEF SUMMARY OF THE INVENTION

An embodiment of the disclosure meets the needs presented above by generally comprising an engagement section which has a shape configured for being abutted against an underside of a head of an actuator knob. A fulcrum section is coupled to one end of the pair of ends of the engagement section. A grip section is coupled to the fulcrum section opposite the engagement section. During use, the engagement section of the lever apparatus is fitted around a body of the actuator knob, and the fulcrum abuts a base to which the actuator knob is movably mounted. The grip section is pressed toward the base to rotate or rock the fulcrum section against the base and pivot the engagement section into the head of the actuator knob, thereby pulling the actuator knob away from the base.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a lever apparatus according to an embodiment of the disclosure.

FIG. 2 is a front view of an embodiment of the disclosure.

FIG. 3 is a side view of an embodiment of the disclosure.

FIG. 4 is a front perspective in-use view of an embodiment of the disclosure.

FIG. 5 is a rear perspective in-use view of an embodiment of the disclosure.

FIG. 6 is a side in-use view of an embodiment of the disclosure. An embodiment of the disclosure hangs on a knob of an actuator prior to pulling the knob away from a base.

FIG. 7 is a side in-use view of an embodiment of the disclosure. An embodiment of the disclosure is pushed on one portion of the apparatus toward a base to pull a knob of an actuator away from the base.

### DETAILED DESCRIPTION OF THE INVENTION

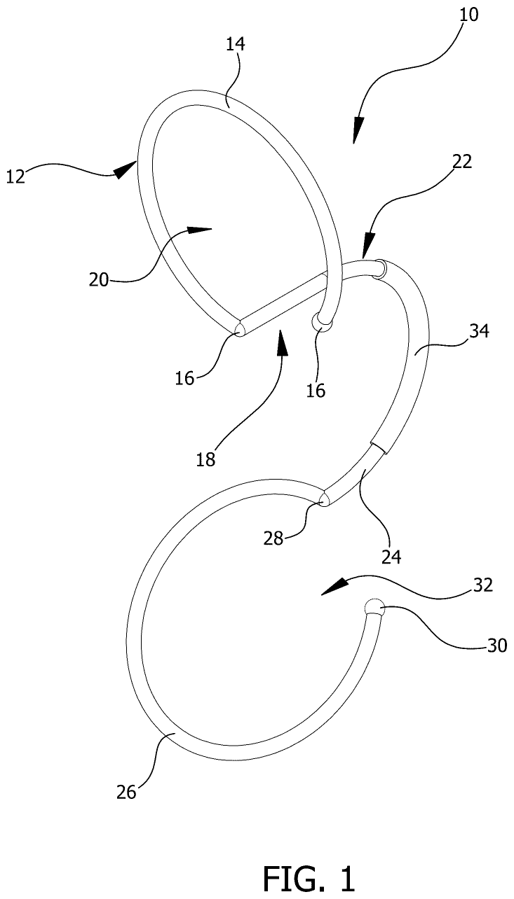

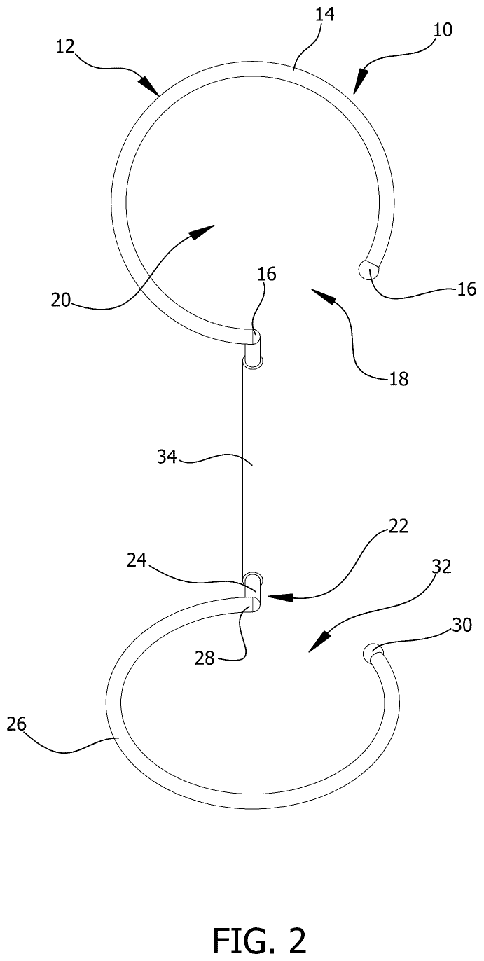

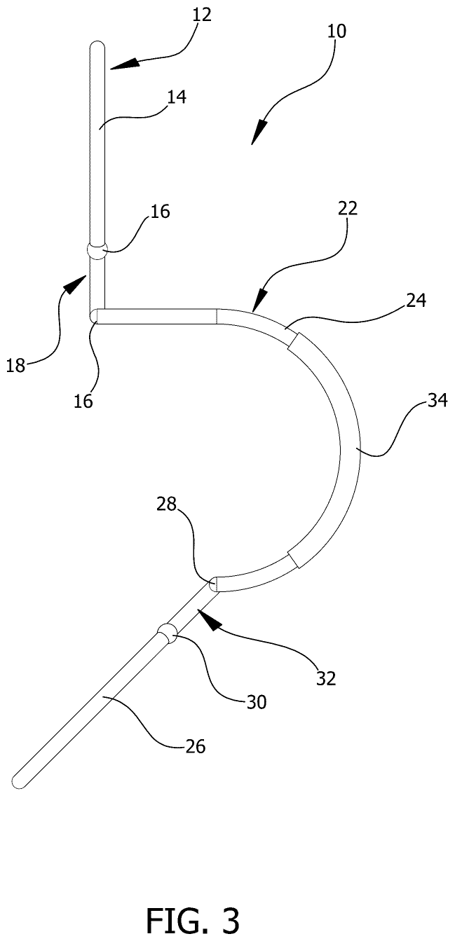

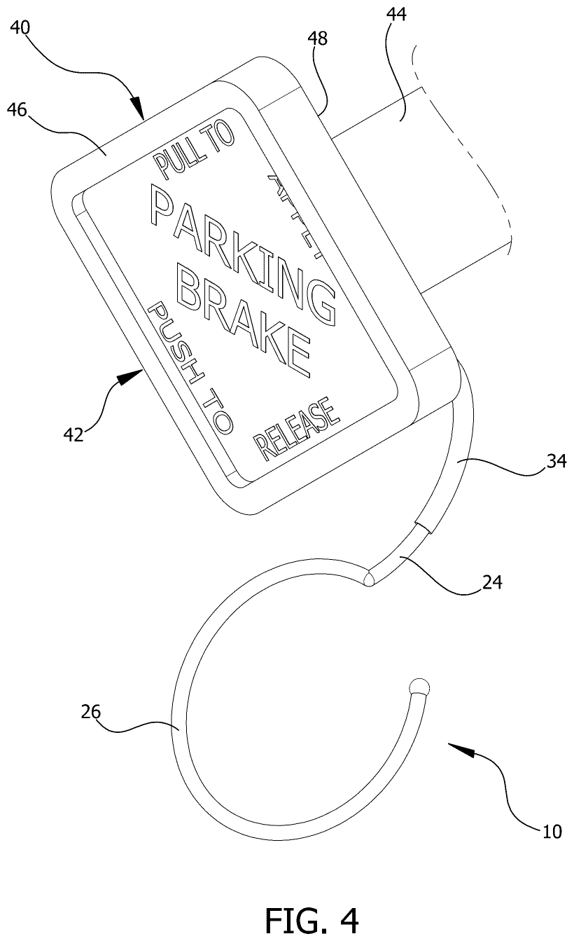

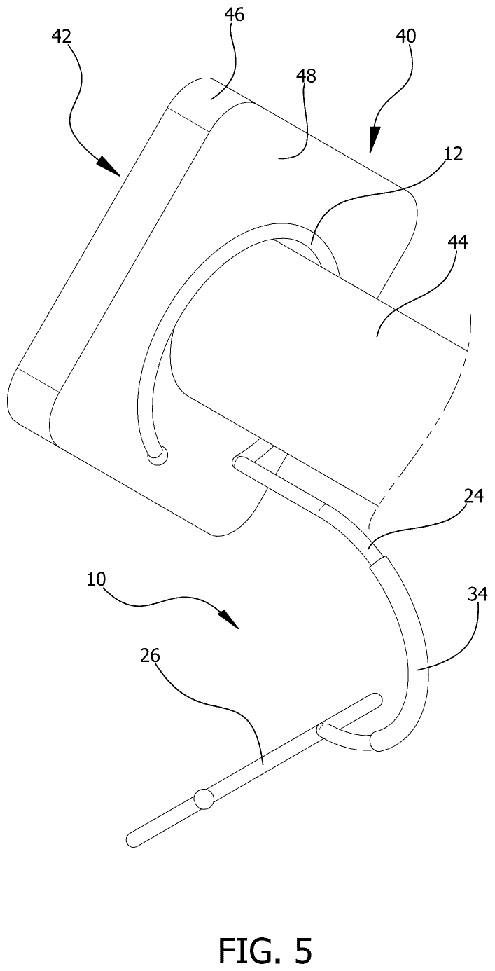

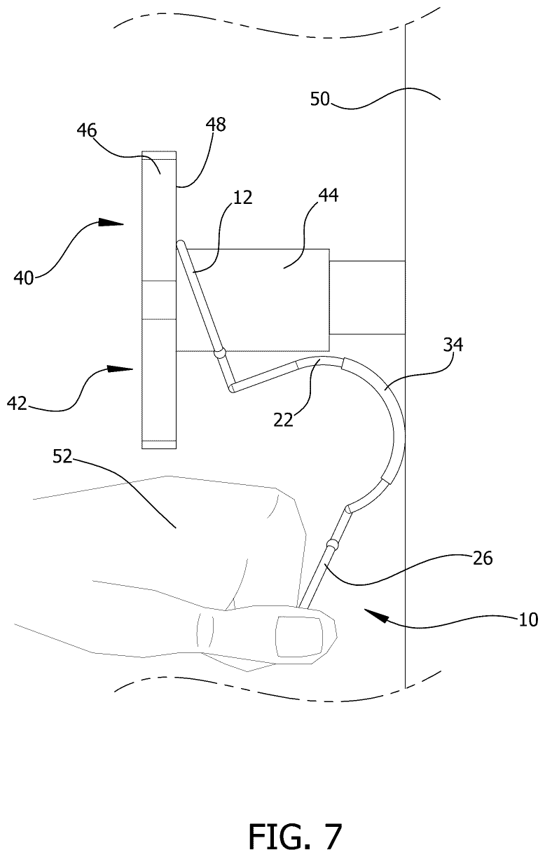

With reference now to the drawings, and in particular to FIGS. 1 through 7 thereof, a new lever embodying the principles and concepts of an embodiment of the disclosure and generally designated by the reference numeral 10 will be described.

As best illustrated in FIGS. 1 through 7, the lever apparatus 10 is generally shaped to engage an actuator 40 which includes a knob 42. The actuator 40 may perform a function such as applying or releasing a brake mechanism for a vehicle when the knob 42 is pulled away from a base 50 to which the knob 42 is movably mounted. The knob 42 has a body 44 and a head 46, wherein the head 46 is attached to the body 44 opposite the base 50. The head 46 has an underside 48 which faces the base 50. Actuators of this type are often used for applying a parking brake for a bus when the knob 42 is pulled away from the base 50 and releasing the parking brake when the knob 42 is pushed toward the base 50. However, the lever apparatus 10 may be used on any such actuator with a knob that is pulled from a base to perform a function.

The lever apparatus 10 is designed to facilitate pulling the knob 42 from the base 50 and generally comprises a continuous rod which forms an engagement section 12, a fulcrum section 22, and a grip section 26. The fulcrum section 22 is coupled to and extends between the engagement section 12 and the grip section 26. The engagement section 12 forms an open loop 14 which defines a gap 18 between a pair of ends 16 of the engagement section 12. The open loop 14 is generally circular but may have a rectangular shape, an ovule shape, a V-shape, or the like. The engagement section 12 is shaped to extend around the body 44 of the knob 42 and engage the underside 48 of the head 46 of the knob 42. The gap 18 may be sized to receive the body 44 of the knob 42 into an interior area 20 defined by the engagement section 12. In some embodiments, the engagement section 12 may be sufficiently resilient such that the engagement section 12 must be stretched to widen the gap 18 to receive the body 44 of the knob 42, then constricts upon releasing the engagement section 12.

In some embodiments, the engagement section 12 may define a closed loop. In such embodiments, the lever apparatus 10 may be used with an actuator in which the knob of the actuator is removable from a base to fit the engagement section 12 around the body of the knob. The engagement section 12 hangs onto the body 44 of the knob 42 during use.

The fulcrum section 22 is coupled to one end 16 of the pair of ends 16 of the engagement section 12. The fulcrum section 22 has a curved shape 24 such that the fulcrum section 22 may move in a rocking motion across the base 50 to urge the engagement section 12 against the head 46 of the knob 42. The grip section 26 is coupled to the fulcrum section 22 opposite the engagement section 12. The grip section 26 has a loop shape which defines a space 32 between a proximal end 28 and a distal end 30 thereof with respect to the fulcrum section 22. The grip section 26 may be operated by a user's hand 52 but does not necessarily need to be grasped or gripped. The grip section 26 may also be operated by a foot or other appendage or tool.

Some embodiments may have an engagement section, a fulcrum section, and a grip section which are not integrally formed. The engagement section, the fulcrum section, and the grip section in such embodiments may be separately formed from each other or removable from each other. Each of the engagement section, the fulcrum section, and the grip section may have varying shapes from those described sufficient for performing the functions described. The grip section may include any of a variety of shapes for gripping or pressing to operate the lever apparatus 10. For example, the grip section may comprise a plate, a pistol grip, an elongated bar, or the like.

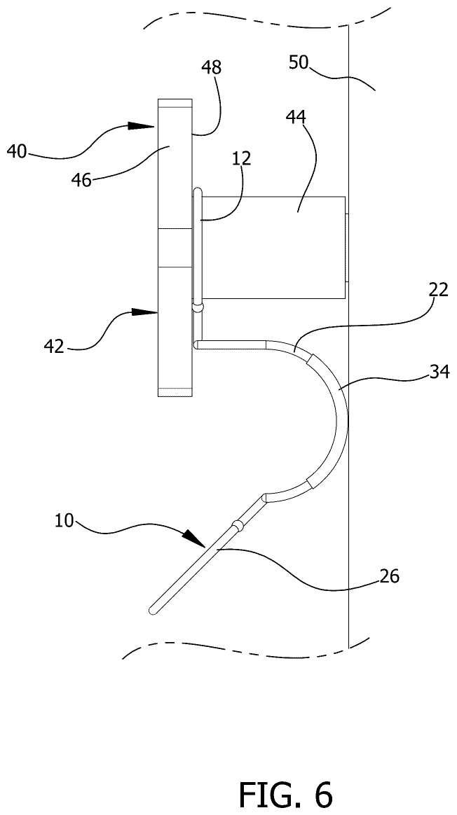

The engagement section 12 lies on a first plane and may lie parallel to the underside 48 of the head 46 during use before pulling the knob 42 as seen in FIG. 6. The engagement section 12 has a front side and a rear side facing opposite directions from each other. The fulcrum section 22 lies on a second plane perpendicular to the first plane. The first and second planes may define an acute angle therebetween or may be parallel in other embodiments. The grip section 26 lies on a third plane which is perpendicular to the second plane and transverse to the first plane. The grip section 26 extends away from the fulcrum section 22 in a direction away from and forwardly with respect to the engagement section 12. Other orientations of the grip section 26 with respect to the engagement section 12 and the fulcrum section 22 may be suitable for pressing the grip section 26 to pull the knob 42.

A cushion member 34 is coupled to the fulcrum section 22. The cushion member 34 is a sleeve which covers an outer side of the fulcrum section 22 but may be a pad or take on other forms in other embodiments. The cushion member 34 comprises a compressible material such that a force exerted by the fulcrum member against the base 50 is dispersed across the base 50. The compressible material may be, for example, rubber, silicone, nylon, or the like.

In use, the lever apparatus 10 is positioned in relation to the knob 42 of the actuator 40 as described above. The grip section 26 may then be pressed toward the base 50 to exert a force through the fulcrum section 22 to the base 50 and rotate the lever apparatus 10 about the fulcrum section 22, thereby forcing the engagement section 12 against the head 46 of the knob 42 away from the base 50. The curve shape of the fulcrum section 22 promotes rocking of the lever apparatus 10 across the outer surface of the fulcrum section 22 rather than pivoting about a point which is fixed with respect to the fulcrum section 22. The dispersal of forces exerted through the fulcrum section 22 against the base 50 facilitate avoiding denting, scratching, or otherwise damaging the base 50.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A lever apparatus for pulling an actuator knob away from a base, the apparatus comprising:
an engagement section having a shape configured for being abutted against an underside of a head of the actuator knob;
a fulcrum section coupled to one end of the pair of ends of the engagement section; and
a grip section coupled to the fulcrum section opposite the engagement section.

2. The apparatus of claim 1, wherein the engagement section has a loop shape.

3. The apparatus of claim 2, wherein the engagement section defines a gap between a pair of ends of the engagement section such that the loop is open.

4. The apparatus of claim 1, wherein the fulcrum section has a curved shape such that the fulcrum section may move in a rocking motion across the base to urge the engagement section against the head of the actuator knob.

5. The apparatus of claim 1, wherein the grip section has a loop shape.

6. The apparatus of claim 5, wherein the grip section defines a space between a proximal end and a distal end thereof with respect to the fulcrum section.

7. The apparatus of claim 1, further comprising a cushion member coupled to the fulcrum section, the cushion member covering an outer side of the fulcrum section, the cushion member comprising a compressible material such that a force exerted by the fulcrum section against the base is dispersed across the base.

8. The apparatus of claim 1, wherein the engagement section, the fulcrum section, and the grip section are integrally formed by a continuous rod.

9. The apparatus of claim 8, wherein the engagement section lies on a first plane, the engagement section having a front side and a rear side facing opposite directions from each other, the fulcrum section lying on a second plane transverse to the first plane.

10. The apparatus of claim 9, wherein the grip section lies on a third plane transverse to the second plane and transverse to the first plane.

11. The apparatus of claim 10, wherein the grip section extends away from the fulcrum section in a direction away from and forwardly with respect to the engagement section.

12. A lever apparatus for pulling an actuator knob away from a base, the apparatus comprising:
an engagement section having a shape configured or being abutted against an underside of a head of the actuator knob, the engagement section having a loop shape, the engagement section defining a gap between a pair of ends of the engagement section such that the loop is open;
a fulcrum section coupled to one end of the pair of ends of the engagement section, the fulcrum section having a curved shape such that the fulcrum section may move in a rocking motion across the base to urge the engagement section against the head of the actuator knob;
a grip section coupled to the fulcrum section opposite the engagement section, the grip section having a loop shape, the grip section defining a space between a proximal end and a distal end thereof with respect to the fulcrum section; and
a cushion member coupled to the fulcrum section, the cushion member covering an outer side of the fulcrum section, the cushion member comprising a compressible material such that a force exerted by the fulcrum section against the base is dispersed across the base;
wherein the engagement section, the fulcrum section, and the grip section are integrally formed by a continuous rod, the engagement section lying on a first plane, the engagement section having a front side and a rear side facing opposite directions from each other, the fulcrum section lying on a second plane perpendicular to the first plane, the grip section lying on a third plane perpendicular to the second plane and transverse to the first plane, the grip section extending away from the fulcrum section in a direction away from and forwardly with respect to the engagement section.
